(19) United States
(12) Patent Application Publication
(10) Pub. No.: US 2005/0264506 A1
(43) Pub. Date: Dec. 1, 2005

(54) Apparatus and method of generating reference data for image signal modification

(76) Inventor: Tae-Sung Kim, Suwon-si (KR)

Correspondence Address: MCGUIREWOODS, LLP, 1750 TYSONS BLVD, SUITE 1800, MCLEAN, VA, 22102, US

(21) Appl. No.: 11/129,573

(22) Filed: May 16, 2005

(30) Foreign Application Priority Data
May 14, 2004 (KR) 10-2004-0034291

(51) Int. Cl. G09G 3/36

(52) U.S. Cl. 345/87

(57) ABSTRACT

A method for generating reference data for modifying image signals of a liquid crystal display includes: selecting at least one pair of previous and target image signals, extracting a response image signal for each selected pair of previous and target image signals, generating a response curve by interpolating the extracted response image signals, and obtaining the reference data from the generated response curve, wherein extracting the response image signal for each selected pair of previous and target image signals includes receiving light from the liquid crystal display when the previous image signal changes to the target image signal, generating a signal according to a luminance level of the received light, converting the generated signal into a digital signal; and processing the digital signal to extract the response image signal.

### CROSS REFERENCE TO RELATED APPLICATION

This application claims priority to and the benefit of Korean Patent Application No. 10-2004-0034291, filed on May 14, 2004, which is hereby incorporated by reference for all purposes as if fully set forth herein.

### BACKGROUND OF THE INVENTION

1. Field of the Invention

The present invention relates to apparatus and method of generating reference data for image signal modification.

2. Description of Related Art

A liquid crystal display (LCD) typically includes a pair of panels including a plurality of pixel electrodes, common electrode, and a liquid crystal (LC) layer provided or sandwiched between the panels and having dielectric anisotropy. The pixel electrodes are arranged in a matrix and connected to switching elements, such as thin film transistors (TFTs), and are supplied, row by row of the matrix, with data voltages through the TFTs. The common electrode covers an entire surface of a panel. The pixel electrodes, the common electrode, and the LC layer provided therebetween form LC capacitors. LC capacitors, along with switching elements, are required for building a pixel for the LCD.

The LCD applies a voltage to the electrodes to generate an electric field in the LC layer. The LCD controls the strength of the electric field to vary the transmittance of light incident on the LC layer to obtain or display a desired image. Periodically reversing the polarity of the data voltages with reference to the common voltage prevents or reduces the deterioration of liquid crystal caused by continuous or long-time application of a unidirectional electric field, etc.

Improving a response time for the liquid crystal to reach a desired luminance level is important when displaying moving images on the LCD. As the size and resolution of LCD devices increase, it is necessary to improve the response time of the liquid crystals. The response time for obtaining the desired luminance level depends on the difference between a target voltage corresponding to a desired luminance level and a previously charged voltage applied across the LC capacitor of the pixel. When the voltage difference is large, the pixel may not reach the desired luminance in a given, e.g., sufficient, period of time to adequately display the image.

Dynamic capacitance compensation (DCC) improves the response time of the liquid crystals such that a desired luminance may be obtained without changing the characteristics of the liquid crystal itself. The DCC applies a greater voltage than the target voltage to the LC capacitor, which reduces the time required for the liquid crystal to reach the desired luminance.

Image signals of a current frame and a previous frame are used to determine a modified image signal of the current frame, which corresponds to a data voltage for compensating the response time of the liquid crystal. To facilitate such modification, the modified image signals are predetermined for a given number of sets of previous image signals and current image signals and stored as reference data. The modified signals for remaining sets of previous image signals and current image signals are interpolated according to the stored reference data.

A lookup table, such as the table shown in FIG. 1, may be used to store the reference data. The row address and the column address indicate the previous and the current image signals, respectively, having gray voltages related to the transmittance of the pixels that are equal to multiples of sixteen, i.e., 16, 48, . . . , 240, and the modification reference data is stored at the intersections of the rows and columns of the lookup table.

In conventional LCDs, modification reference data is obtained by trial and error, not through measurement or interpolation, which increases the time for measuring and determining an appropriate luminance level. Further, determining the luminance level to obtain the modification reference data invites human error since the luminance level is measured using human sight and the luminance level changes according to environmental conditions.

### SUMMARY OF THE INVENTION

The present invention discloses a method of generating reference data for modifying image signals of a liquid crystal display, the method including selecting at least one pair of previous and target image signals, extracting a response image signal for each selected pair of previous and target image signals, generating a response curve by interpolating the extracted response image signals, and obtaining the reference data from the generated response curve, wherein extracting the response image signal for each selected pair of previous and target image signals comprises receiving light from the liquid crystal display when the previous image signal changes to the target image signal, generating a signal according to a luminance level of the received light, converting the generated signal into a digital signal, and processing the stored digital signal to extract the response image signal.

The present invention also discloses an apparatus for generating reference data for image signal modification, the apparatus including a luminance measurement unit receiving light from the liquid crystal display according to a previous image signal changing to a target image signal and generating a signal according to a measured luminance level of the received light, a data acquisition unit acquiring the generated signal from the luminance measurement unit and converting the generated signal into a digital signal, and a signal processing unit receiving the digital signal from the data acquisition unit, storing the digital signal, filtering the digital signal, averaging the filtered digital signal for a predetermined time to extract a first image signal corresponding to the previous image signal and to extract a second image signal corresponding to the second image signal, extracting a response image signal according to the first image signal and the second image signal, respectively, interpolating the response image signal to generate a response curve, and obtaining the reference data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 shows a lookup table.

FIG. 2 is a block diagram of an LCD according to an embodiment of the invention.

FIG. 3 is a block diagram of a signal controller of an LCD according to an embodiment of the invention.

FIG. 4 is a block diagram of a device for generating modification reference data according to an embodiment of the invention.

FIG. 5 is a flow chart illustrating a method of generating modification reference data according to an embodiment of the invention.

FIGS. 6A and 6B show waveforms of measured luminance response of the LCD.

FIG. 7 illustrates waveforms of filtered and averaged luminance response when the gray of “128” is changed into “160”.

FIG. 8 illustrates the result of applying various types of interpolation.

FIG. 9 illustrates the calculation of the reference data using interpolation.

FIG. 10 illustrates an example of the calculation of the reference data by interpolating the extracted data.

FIGS. 11A and 11B show the reference data for the vertical synchronization frequency equal to 60 Hz and 75 Hz, respectively.

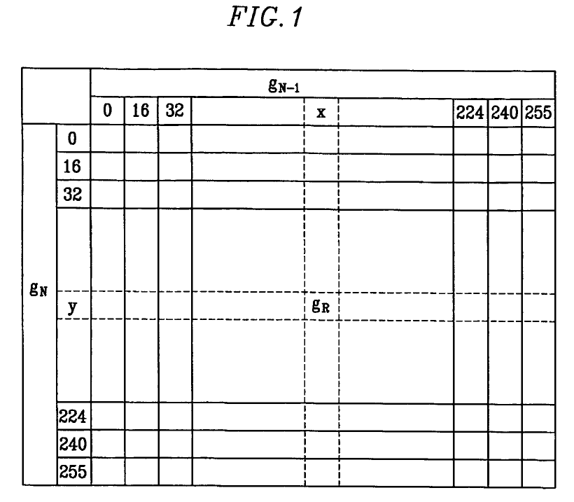

### DETAILED DESCRIPTION OF PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures. In particular, an apparatus and method of generating reference data for image signal modification according to embodiments of the invention will be described with reference to the accompanying drawings.

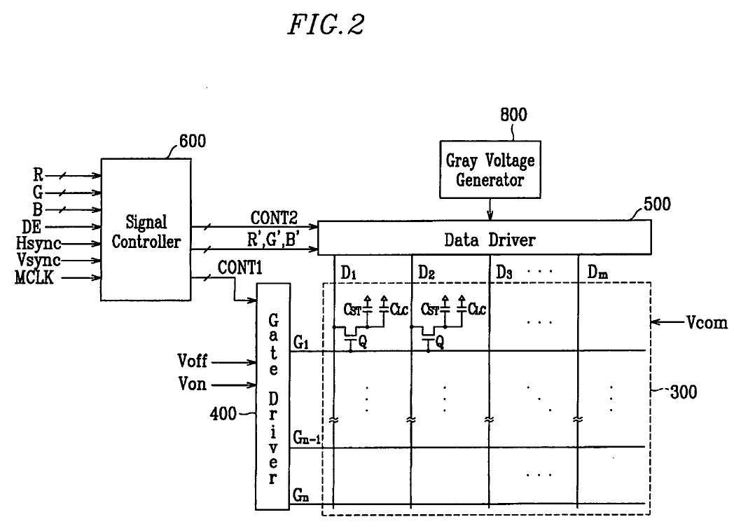

FIG. 2 is a block diagram of an LCD according to an embodiment of the invention. Referring to FIG. 2, an LCD includes an LC panel assembly 300, a gate driver 400 and a data driver 500 that are both connected to the panel assembly 300, a gray voltage generator 800 connected to the data driver 500, and a signal controller 600 controlling the above described elements.

The panel assembly 300 includes a plurality of display signal lines G₁-Gₙ and D₁-Dₘ and a plurality of pixels connected thereto, which are arranged substantially in a matrix or array.

The display signal lines G₁-Gₙ and D₁-Dₘ include a plurality of gate lines G₁-Gₙ transmitting gate signals (often referred to as “scanning signals”), and a plurality of data lines D₁-Dₘ transmitting data signals. The gate lines G₁-Gₙ extend substantially in a row, or horizontal, direction and the gate lines G₁-Gₙ are positioned substantially parallel with each other, while the data lines D₁-Dₘ extend substantially in a column, or vertical, direction and are positioned substantially parallel with each other. Thus, the gate lines G₁-Gₙ are provided substantially perpendicular to the D₁-Dₘ.

Each pixel includes a switching element Q that is connected with the signal lines G₁-Gₙ and D₁-Dₘ, and a LC capacitor C_{LC} and a storage capacitor C_{ST} that are each connected with the switching element Q. The storage capacitor C_{ST} is not always necessary and may be omitted from the LCD.

The gray voltage generator 800 generates two sets of a plurality of gray voltages relating to the transmittance of the pixels. For example, one set of gray voltages has a positive polarity or charge with respect to the common voltage Vcom, and another set of gray voltages has a negative polarity or charge with respect to the common voltage Vcom.

The gate driver 400 supplies gate signals, which are generated from an external device, to the gate lines G₁-Gₙ, which are connected with the panel assembly 300 For example, the gate signals applied to the gate lines G₁-Gₙ include a gate-on voltage Von and a gate-off voltage Voff.

The data driver 500, which is connected with the data lines D₁-Dₘ of the panel assembly 300, selects gray voltages from the gray voltage generator 800 and transmits the selected gray voltages to the data lines D₁-Dₘ as data signals.

The gate driver 400 or the data driver 400 may further include a plurality of driver integrated circuits (ICs) that are mounted on or directly on the panel assembly 300 and/or are mounted on or directly on flexible printed circuit films to form tape carrier packages attached to the panel assembly 300. Alternatively, the gate driver 400 or the data driver 500 may be integrated with at least one of the panel assembly 300, the switching element Q, and the signal lines G₁-Gₙ and D₁-Dₘ.

The signal controller 600 controls, for example, at least the gate driver 400, the data driver 500, the LC panel assembly 300, and the gray voltage generator 800 connected with the data driver 500. The operation of the LCD is further described hereinbelow.

As shown in FIG. 2, for example, signals, such as image signals R, G, and B, and control signals, such as input control signals controlling the display thereof, are input to the signal controller 600 from an external device, such as a graphic controller (not shown). The control signals may be, for example, a vertical synchronization signal Vsync, a horizontal synchronization signal Hsync, a main clock signal MCLK, a data enable signal DE, etc.

The signal controller 600 modifies the input image signals R, G and B according to operating conditions of the panel assembly 300 and provides the modified image signals R′, G′ and B′ to the data driver 500. The signal controller 600 also generates a plurality of gate control signals CONT1 and data control signals CONT2 according to the input image signals and the input control signals and provides the gate control signals CONT1 to the gate driver 400 and the data control signals CONT2 to the data driver 500.

The gate control signals CONT1 provided to the gate driver 400 include, for example, at least a scanning start signal STV to instruct the gate driver 400 to scan the gate-on voltage Von to determine whether the gate-on voltage Von is sufficiently provided, and a clock signal to control the output timing of the gate-on voltage Von. The gate control signals CONT1 may further include an output enable signal OE to define or set the duration of the gate-on voltage Von.

The data control signals CONT2 include, for example, a horizontal synchronization start signal STH to inform the data driver 500 of the start of data transmission for a pixel row, a load signal LOAD to instruct the data driver 500 to apply the data voltages to the data lines D₁-Dₘ, and a data clock signal HCLK. The data control signals CONT2 may further include an inversion control signal RVS to reverse the polarity of the data voltages (with respect to the common voltage Vcom).

The data driver 500 receives a packet of the modified image data signals R′, G′ and B′ for a pixel row from the signal controller 600 upon receiving the data control signals CONT2 from the signal controller 600, converts the image data R′, G′ and B′ into analog data voltages selected from the gray voltages received from the gray voltage generator 800, and applies the selected analog data voltages to the data lines D₁-Dₘ.

The gate driver 400 responds to the gate control signals CONT1, which is received from the signal controller 600, and applies the gate-on voltage Von to the gate line G₁-Gₙ, thereby turning on the switching elements Q connected thereto. The data voltages applied to the data lines D₁-Dₘ are supplied to corresponding pixels via the turned-on switching elements Q.

The above-described procedure is repeated for each predetermined unit corresponding to a horizontal period (the horizontal period may be denoted by “1 H” and is equivalent to one period of the horizontal synchronization signal Hsync and the data enable signal DE) until all gate lines G₁-Gₙ are sequentially supplied with the gate-on voltage Von during a frame of the image signal, thereby applying the data voltages to all pixels. The polarity of the data voltage is reversed (which is referred to as “frame inversion”) according to an inversion control signal RVS sent to the data driver 500 before repeating the above-described process with another frame of the image signal.

According to another embodiment of the invention, the inversion control signal RVS may be controlled such that the polarity of the data voltages flowing through a data line in one frame are reversed (e.g., line inversion), or the polarity of the data voltages in one packet are reversed (e.g., column inversion).

The modification of the image signals according to an embodiment of the invention is described with reference to FIG. 3. For descriptive convenience, the image signals g_{N-1} and g_{N} of the (N-1)-th and the N-th frames are referred to as “current” and “previous” image signals, respectively.

FIG. 3 is a block diagram of a signal controller of an LCD according to an embodiment of the invention. As shown in FIG. 3, the signal controller includes a signal receiver 610, a frame memory 620 connected with the signal receiver 610, a lookup table (LUT) 630 connected with the signal receiver 610 and the frame memory 620, and a calculator 640connected with the lookup table 630, the signal receiver 610, and the frame memory 620. The calculator 640 outputs signals from the image signal modifier 650.

Upon receiving an image signal g_{M} from a signal source (not shown), the signal receiver 610 converts the image signal g_{M} into another image signal g_{N} so that the converted image signal g_{N} may be subsequently processed by the signal controller 600. The signal receiver 610 provides the converted image signal g_{N} as a current image signal for the frame memory 620, the lookup table 630, and the calculator 640.

The frame memory 620 provides the lookup table 630 and the calculator 640 with a previous image signal g_{N-1} stored therein and stores the current image signal g_{N} received from the signal receiver 610. According to an embodiment of the invention, the frame memory 620 may be externally provided, e.g., not integral to the signal controller 600.

The lookup table 630 outputs modification reference data g_{R} to the calculator 640 according to the current image signal g_{N} supplied from the signal receiver 610 and the previous image signal g_{N-1} supplied from the frame memory 620. For example, the lookup table 630 may be expressed in the form of a matrix, such as a 17×17 matrix.

The calculator 640 generates, e.g., interpolates, a modified image signal g_{N}′ according to the modification reference data g_{R}, the current image signal g_{N}, and the previous image signal g_{N-1}.

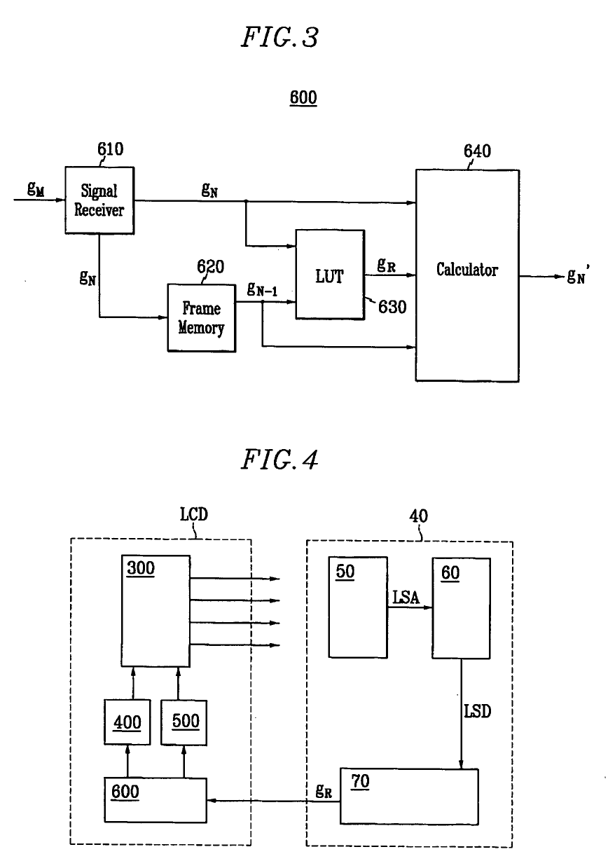

FIG. 4 is a block diagram of a device for generating modification reference data g_{R} according to an embodiment of the invention. Referring to FIG. 4, a device for generating modification reference data 40 includes a luminance measurement unit 50, a data acquisition unit 60, and a signal processing unit 70.

The luminance measurement unit 50 receives light from an LCD displaying a measurement pattern and generates an analog signal LSA corresponding to the luminance of the light received from the LCD. The luminance measurement unit 50 measures the light received from the LCD at more than one position of the LCD. For example, the luminance measurement unit 50 may include a photo detector and/or another luminance measurement device, such as “BM7,” etc.

The data acquisition unit 60 receives the analog signal LSA from the luminance measurement unit 50, converts the analog signal LSA into a digital signal LSD, and sends the digital signal LSD to the signal processing unit 70. The data acquisition unit 60 may be, for example, a data acquisition system such as an oscilloscope.

The signal processing unit 70 receives the digital signal LSD and stores the digital signal LSD into a memory or a storing device. The signal processing unit 70 filters the digital signal LSD to remove noise components. The signal processing unit 70 also generates the modification reference data g_{R} according to a mathematical formula, such as through averaging, interpolation, etc. The modification reference data g_{R} is stored in the lookup table 630 of the signal controller 600. The signal processing unit 70 is implemented via an electronic device such as, for example, a computer using a software program, such as “MATLAB.”

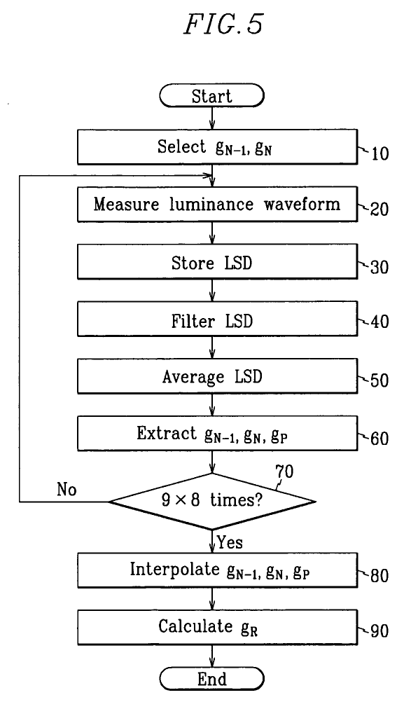

A method of generating modification reference data g_{R} is described with reference to FIG. 5. FIG. 5 is a flow chart showing a method of generating modification reference data g_{R} according to an embodiment of the invention. Again, for descriptive convenience, a previous image signal g_{N-1} is referred to as a previous gray and a target image signal g_{N} is referred to as a target gray.

Previous grays g_{N-1} and target grays g_{N} are selected in operation 10. Considering, for example, a 17×17 matrix lookup table as described above, the selected previous grays g_{N-1} and target grays g_{N} are 0, 32, 64, . . . , 255 and remaining grays equal to multiples of 16, i.e., 16, 48, . . . , 240 are obtained through interpolation or estimation, which reduces the number of measurements performed. It is understood that the size of the lookup table is not limited to the above-described embodiment. It is also understood that the level of the previous grays g_{N-1} and the target grays g_{N} may be varied.

In operation 20, luminance levels of waveforms of light are measured from images displayed from an LCD. The image signals transmitted to the LCD to display images makes it possible for there to be many combinations of the previous gray g_{N-1} and the target gray g_{N}.

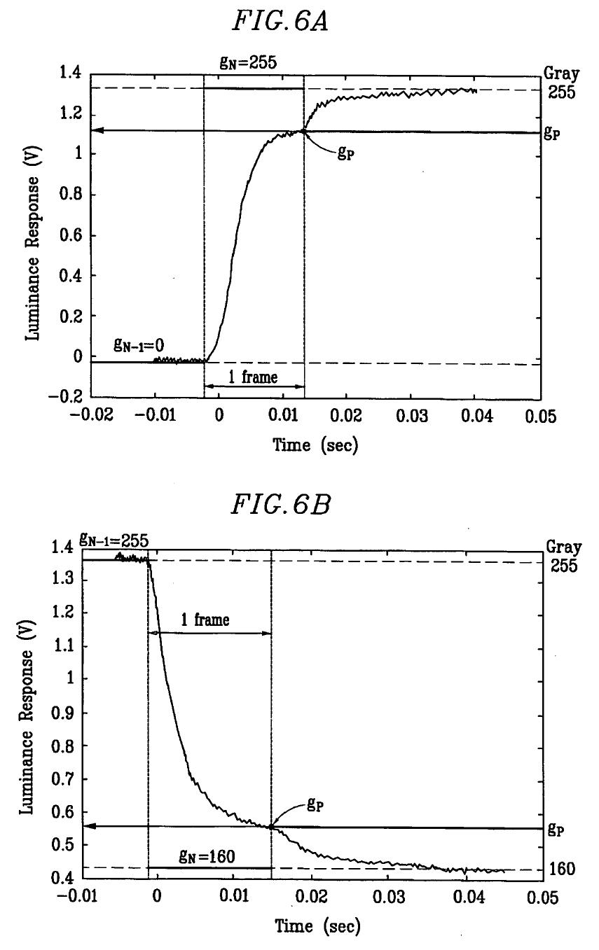

FIGS. 6A and 6B show waveforms of measured luminance response of the LCD. FIG. 6A shows the luminance response for the previous gray g_{N-1}, which is equivalent to “0” and the target gray g_{N}, which is equivalent to “255.” FIG. 6B shows the luminance response for the previous gray g_{N-1}, which is equivalent to “255” and the target gray g_{N}, which is equivalent to “160.” As shown in FIGS. 6A and 6B, the LCD does not reach the target luminance corresponding to the target gray g_{N} during one (1) frame, but instead shows the luminance corresponding to a response gray gₚ.

In operation 30, the measured response waveform is converted into data LSD and stored. Mathematical operations or calculations are performed on the stored data LSD to obtain modification reference data g_{R}. For example, in operation 40, the stored data LSD is filtered, and in operation 50, the filtered data LSD is averaged to determine the average of the filtered data LSD.

FIG. 7 illustrates waveforms of filtered and averaged luminance response when the gray of “128” is changed to “160.” As shown in FIG. 7, a small change of gray yields or generates a lot of noise and/or distortion in the luminance response waveform. Filtering the luminance response waveform removes such noise, thereby improving the accuracy of the interpolation or estimation calculation. Further, the filtered waveform is averaged to obtain substantially exact levels of the previous gray g_{N-1} and the target gray g_{N}. For example, in FIG. 7, the averaging is performed for the shaded regions.

The previous gray g_{N-1} and the target gray g_{N} are extracted after the averaging operation is completed. In operation 60, a luminance level of the previous gray g_{N-1} is extracted when the luminance level of the previous gray g_{N-1} in a frame begins to change and a corresponding response gray gₚ is calculated. The measured luminance level is represented as a voltage value and the corresponding response gray gₚ has a one-to-one correspondence with the voltage value.

In operation 70, operations 20 through 60 discussed above are repeated for all of the combinations of the previous gray g_{N-1} and the target gray g_{N}. For example, in the above-described embodiment and as shown in FIG. 5, operations 20 through 60 are repeated seventy-two (72), i.e., 9×8 times.

The luminance response waveform does not need to be measured and processed when there is no change from the previous gray g_{N-1} to the target gray g_{N} because there is no change in the luminance response waveform. Thus, the modification reference data g_{R} is equal, or determined to be equal, to the previous gray g_{N-1} and the target gray g_{N}.

In operation 80, upon measuring all combinations of the previous grays g_{N-1} and the target grays g_{N} and extracting all data g_{N-1}, g_{N}, and gₚ, interpolation is performed based on extraction time. In operation 90, modification reference data g_{R} is calculated or determined based on the interpolation.

Modification reference data g_{R} may be calculated from the extracted data using any of the following interpolation techniques: nearest neighbor interpolation, linear interpolation, piecewise cubic spline interpolation, or piecewise cubic Hermite interpolation. It is understood that the interpolation techniques used to calculate the modification reference data g_{R} are not limited to the four interpolation techniques listed above.

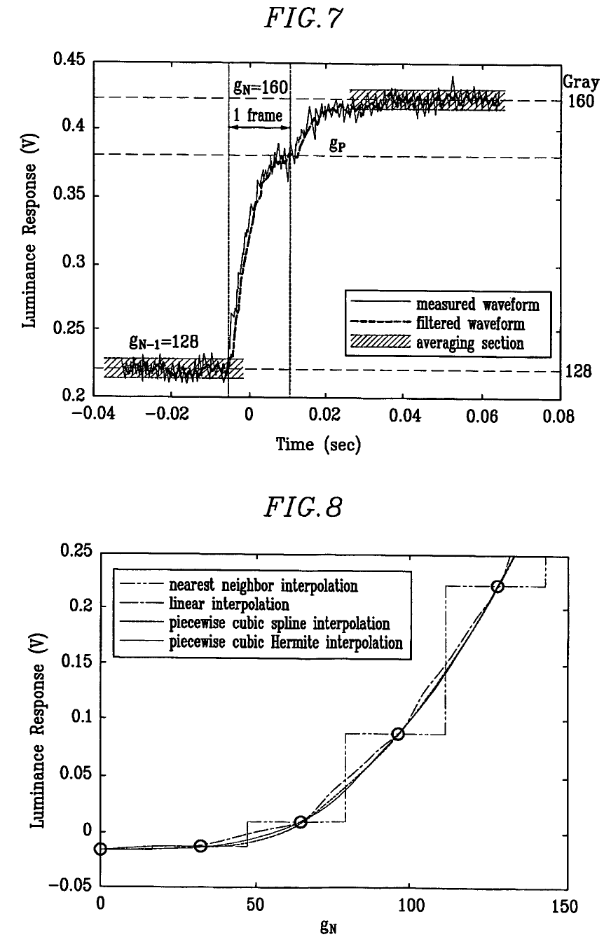

FIG. 8 illustrates the results of various interpolation techniques used for calculating the modification reference data g_{R} from the extracted data. As shown, the target gray was varied for each previous gray g_{N-1}. The above-described four interpolation methods are used to interpolate the extracted response gray gₚ, which are indicated by circles shown in FIG. 8. As shown in FIG. 8, the nearest neighbor interpolation and the linear interpolation are less accurate than the piecewise cubic spline interpolation and the piecewise cubic Hermite interpolation

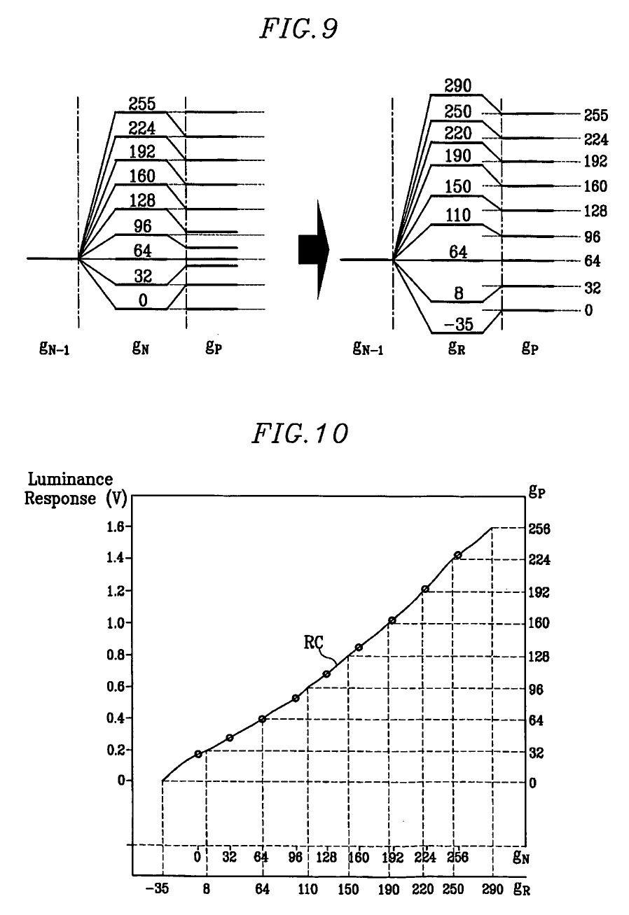

A method of obtaining the modification reference data g_{R} according to the interpolated extracted data is described hereinbelow with reference to FIGS. 9 and 10. FIG. 9 illustrates the calculation of the modification reference data g_{R} using interpolation. FIG. 10 illustrates an example of the calculation of the modification reference data g_{R} by interpolating the extracted data.

The left side of FIG. 9 shows the response gray gₚ extracted by measuring the luminance when the previous gray g_{N-1}, which is equal to 64, is changed into the target grays g_{N}, which are equal to 0, 32, 96, . . . , 255, respectively. The area occupied by the response gray gₚ is smaller than the area occupied by the target gray g_{N} since the response gray gₚ does not reach the target gray g_{N} due to the response time of liquid crystal. Further, the distance between the levels of the response gray gₚ is typically not uniform. The distance between the levels of the response gray gₚ is made uniform through interpolation, as shown in the right side of FIG. 9. Interpolation causes the levels of the target gray g_{N} to shift and the shifted levels of the target gray g_{N} are used as modification reference data g_{R}. For example, when changing the luminance level from the 64-th gray g_{N-1} to the 160-th gray gₚ, the 190-th gray g_{N} is applied for a frame.

For example, as shown in FIG. 10, points corresponding to the extracted target gray g_{N} and the response gray gₚ are depicted on a graph (denoted by circles) and a luminance response curve RC is applied to the graph by interpolating the extracted target gray g_{N} and the response gray gₚ. The left vertical axis indicates voltage values corresponding to the luminance response, which vary depending on the measurement devices used to measure the luminance level, the right vertical axis indicates the response gray gₚ corresponding to the luminance response, and the horizontal axis indicates the target gray g_{N} and the obtained modification reference data g_{R}. In a non-limiting example, lines are drawn from the right vertical axis, each line represents a unit of 32 grays. Projecting the intersections between the horizontal lines and the luminance response curve onto the horizontal axis yields the modification reference data g_{R}, which in FIG. 10 is equal to −35, 8, 64, . . . , 250, 290. Since the grays are represented by eight bit ranges from zero to 255, the values out of this range are substituted with zero or 255.

The modification reference data g_{R} for each previous gray g_{N-1} may be obtained using the graph shown in FIG. 10, or a graph similar thereto. A lookup table may be formed using the obtained modification reference data g_{R}, for example, a 9×9 lookup table may be formed using the obtained modification reference data g_{R}. Another lookup table may be formed using the results of a second interpolation of the previous gray g_{N-1} and the target gray g_{N}, for example, the modification reference data g_{R} generated from the second interpolation of the previous gray g_{N-1} and the target gray g_{N} may be used to form a 17×17 lookup table. The second interpolation may be omitted. As previously described, the size of the lookup table may vary and the number of modification reference data g_{R} generated may be adjusted depending on the size of the lookup table.

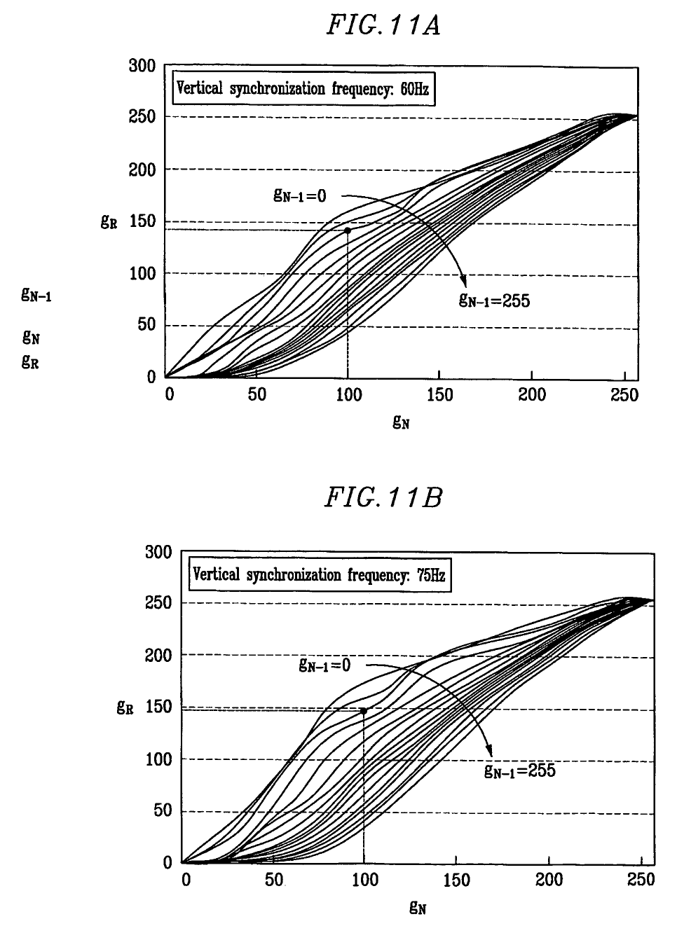

The modification reference data g_{R} forming the 17×17 lookup table is illustrated in FIGS. 11A and 11B. FIGS. 11A and 11B show the reference data for a 60 Hz vertical synchronization frequency and a 75 Hz vertical synchronization frequency, respectively. The horizontal axis represents the target gray g_{N} and the vertical axis represents the reference data g_{R}. A plurality of curves correspond to respective levels of the previous gray g_{N-1}. For example, the points on the third curve from the uppermost curve shown in FIGS. 11A and 11B indicate that the modification reference data g_{R} is equal to 145 and 149, respectively, when the previous gray g_{N-1} equal to 32 moves to the target gray g_{N} equal to 96. As shown in FIGS. 11A and 11B, modification reference data g_{R} for the vertical synchronization frequency of 75 Hz is distributed wider than modification reference data g_{R} for the vertical synchronization frequency of 60 Hz and thus additionally compensates the image signals.

When a luminance response waveform for a vertical synchronization frequency (e.g. 60 Hz) is measured and stored, the reference data g_{R} for other vertical synchronization frequencies may be calculated using the stored luminance response waveform without measuring luminance response waveforms for the other frequencies. For example, when a 60 Hz response waveform is used for a vertical synchronization frequency of 75 Hz, a time for one frame is reduced from 16 ms into 13 ms and the response gray gₚ are extracted at this time. The remaining operations are performed in the same manner as those described above. In other words, for example, a time period corresponding to one frame is varied and the response grays gₚ are extracted at the end of the time period.

Further, when a luminance response waveform is stored, the reference data g_{R} for changing the degree of the image signal modification may be obtained using the stored luminance response waveform without performing additional measurements for obtaining luminance response waveforms. The reference data may be obtained according to the same process as described above.

As described above, the embodiments of the present invention reduce the number of measurements of luminance waveform necessary for generating the reference data. Further, reference data may be more accurately obtained since such data is obtained through interpolation or other mathematical calculations and does not rely on human sight or guessing. Previously measured and stored data may be used even when a measurement condition is changed, for example, when the vertical synchronization frequency changes or the degree of the image signal modification changes, thereby reducing the time and the cost needed for additional measurements. Moreover, the above-described method may be applicable to individual LCD products such that the response time for the liquid crystals to obtain the desired luminance may be individually improved without changing the characteristics of the liquid crystal itself for each product being produced, thereby improving the quality of the LCD.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method of generating reference data for modifying image signals of a liquid crystal display, comprising:
selecting at least one pair of previous and target image signals;
extracting a response image signal for each selected pair of previous and target image signals;
generating a response curve by interpolating the extracted response image signals; and
obtaining the reference data from the generated response curve,
wherein extracting the response image signal for each selected pair of previous and target image signals comprises:
receiving light from the liquid crystal display when the previous image signal changes to the target image signal; generating a signal according to a luminance level of the received light; converting the generated signal into a digital signal; and processing the digital signal to extract the response image signal.

2. The method of claim 1, wherein processing the digital signal comprises:
filtering the digital signal to remove noise.

3. The method of claim 2, wherein the processing the digital signal further comprises:
averaging the filtered digital signal for a predetermined period of time;
extracting a first image signal corresponding to the previous image signal; and
extracting a second image signal corresponding to a second image signal.

4. The method of claim 3, wherein the response image signals are interpolated based on the first image signal and the second image signal.

5. The method of claim 4, wherein the reference data corresponds to the interpolated response image signals, which are uniformly provided on the response curve.

6. The method of claim 1, wherein each of the response image signals corresponds with the filtered digital signal at a time after a frame ends and the previous image signal has changed to the target image signal.

7. The method of claim 1, wherein each of the response image signals corresponds with the filtered digital signal after a predetermined time passes from when the previous image signal changed to the target image signal,
wherein the predetermined time is determined according to a degree of image signal modification of the liquid crystal display.

8. The method of claim 1, wherein the previous image signal, the target image signal, and the response image signals are gray image signals.

9. The method of claim 1, further comprising:
storing the digital signals into a memory device prior to extracting the response image signal.

10. The method of generating reference data for modifying image signals of a liquid crystal display of claim 1, wherein the generating the signal according to the luminance level of the received light comprises:
generating the signal to be processed for extracting the response image signal when there is a change in luminance between the previous image signal and the target image signal such that a luminance response waveform is not generated when there is no change

11. An apparatus for generating reference data for image signal modification, comprising:
a luminance measurement unit receiving light from the liquid crystal display according to a previous image signal changing to a target image signal and generating a signal according to a measured luminance level of the received light;
a data acquisition unit acquiring the generated signal from the luminance measurement unit and converting the generated signal into a digital signal; and
a signal processing unit receiving the digital signal from the data acquisition unit, storing the digital signal, filtering the digital signal, averaging the filtered digital signal for a predetermined time to extract a first image signal corresponding to the previous image signal and to extract a second image signal corresponding to the second image signal, extracting a response image signal according to the first image signal and the second image signal, respectively, interpolating the response image signal to generate a response curve, and obtaining the reference data.

12. The apparatus of claim 11, wherein the response image signal corresponds with the filtered digital signal after a predetermined time passes from when the previous image signal changes to the target image signal, and the predetermined time is determined based on a degree of image signal modification of the liquid crystal display.

13. A method for generating data for image signal modification of a liquid crystal display device, comprising:
selecting at least one pair of previous and target gray signals;
extracting a response gray signal for each selected pair of previous and target gray signals and extracting the previous gray signal and the target gray signal;
generating a response curve by interpolating the extracted response gray signal, the extracted previous gray signal, and the extracted target gray signal; and
obtaining data for image signal modification from the generated response curve,
wherein the interpolation shifts levels of the target gray signal and the shifted levels of the target gray signal are used as the data for image signal modification.

14. The method of generating data for image signal modification, wherein extracting the response gray signal for each selected pair of previous and target gray signals comprises:
receiving light from the liquid crystal display when the previous gray signal changes to the target gray signal;
generating a signal according to a luminance level of the received light;
converting the generated signal into a digital signal; and
processing the digital signal to extract the response image signal.
